(19) United States
(12) Patent Application Publication
(10) Pub. No.: US 2022/0311771 A1
(43) Pub. Date: Sep. 29, 2022

(54) INFORMATION PROCESSING APPARATUS, NON-TRANSITORY COMPUTER READABLE MEDIUM, AND INFORMATION PROCESSING METHOD

(71) Applicant: FUJIFILM Business Innovation Corp., Tokyo (JP)

(72) Inventor: Junya KATO, Kanagawa (JP)

(73) Assignee: FUJIFILM Business Innovation Corp., Tokyo (JP)

(21) Appl. No.: 17/396,956

(22) Filed: Aug. 9, 2021

(30) Foreign Application Priority Data
Mar. 24, 2021 (JP) 2021-049716

(51) Int. Cl. H04L 29/06; G06F 16/215

(52) U.S. Cl. CPC H04L 63/10; H04L 63/08; G06F 16/215

(57) ABSTRACT

An information processing apparatus includes: a processor configured to: provide, in an own system, an account linking service for performing account linking with an external service; and when the account linking service receives a notification indicating that an account of a user is invalidated from the external service with which the account linking is performed, delete an account of the user in an own service, and invalidate or forcibly delete an account of the own system linked with the invalidated account.

### CROSS-REFERENCE TO RELATED APPLICATIONS

This application is based on and claims priority under 35 USC 119 from Japanese Patent Application No. 2021-049716 filed Mar. 24, 2021.

### BACKGROUND

### (i) Technical Field

The present disclosure relates to an information processing apparatus, a non-transitory computer readable medium, and an information processing method.

### (ii) Related Art

JP-A-2018-098657 discloses an information processing apparatus configured to specify and delete, from stored user information of plural users, user information of a user whose use history satisfies a predetermined condition.

JP-A-2020-038438 discloses a management system in which, when a management server of a portal site receives an ID linking request from a management server of an on-premises environment of a linking destination, the management server transmits an ID linking confirmation mail to a user terminal and requests an input of an internal management ID, and executes ID linking only when the input internal management ID is correct.

### SUMMARY

According to an existing method, in a case where a service provided to a certain user group performs account linking with an external service while services are being provided to plural user groups in one system, when an account of a certain user in the external service is invalidated due to retirement or the like, the account of the user is also invalidated and cannot be used in a service in which the external service and the account are linked with each other.

However, even when such a method is used, in a service in which the account linking with the external service is not performed, the account of the user remains in a valid state, and the service may be illegally used even the authority to use the service is not given.

Aspects of non-limiting embodiments of the present disclosure relate to providing an information processing apparatus, a non-transitory computer readable medium, and an information processing method capable of invalidating not only an account of a user in a service linked with an external service but also an account of the user in a service not linked with the external service when the account of the user in the external service is invalidated in a situation where a service provided to a certain user group links with the external service while the service is being provided to plural user groups in one system.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

According to an aspect of the present disclosure, there is provided an information processing apparatus includes: a processor configured to: provide, in an own system, an account linking service for performing account linking with an external service; and when the account linking service receives a notification indicating that an account of a user is invalidated from the external service with which the account linking is performed, delete an account of the user in an own service, and invalidate or forcibly delete an account of the own system linked with the invalidated account.

### BRIEF DESCRIPTION OF THE DRAWINGS

Exemplary embodiment(s) of the present disclosure will be described in detail based on the following figures, wherein:

FIG. 1 is a diagram showing a system configuration of an information processing system according to one exemplary embodiment of the present disclosure;

FIG. 2 is a diagram illustrating a multi-tenant configuration;

FIG. 3 is a diagram illustrating a state in which ID linking is performed between an external service provided by an external service server 40 and an ABC service provided by a service providing server 10;

FIG. 4 is a diagram illustrating a state in which an account of a user X registered in a tenant in the external service is deleted due to retirement or the like;

FIG. 5 is a diagram showing a hardware configuration of the service providing server 10 in the information processing system according to the exemplary embodiment of the present disclosure;

FIG. 6 is a block diagram showing a functional configuration of the service providing server 10;

FIG. 7 is a sequence chart for illustrating operations when the ID linking is performed between the external service and cloud service ABC;

FIG. 8 is a sequence chart for illustrating operations in a case where a user who has ID linking with the external service is performed loses a right of using both the external service and the cloud service ABC due to retirement or the like;

FIG. 9 is a diagram illustrating a configuration in a case where an ID linking tenant 50 is provided in the cloud service ABC;

FIG. 10 is a diagram illustrating operations in a case where a user ID of a user whose account is invalidated in the external service is invalidated;

FIG. 11 is a diagram illustrating operations in a case where a user ID of a user whose account is invalidated in the external service is forcibly deleted;

FIG. 12 is a sequence chart for illustrating the operations in the case where the user ID of the user whose account is invalidated in the external service is invalidated; and

FIG. 13 is a sequence chart for illustrating the operations in the case where the user ID of the user whose account is invalidated in the external service is forcibly deleted.

### DETAILED DESCRIPTION

Next, exemplary embodiments of the present disclosure will be described with reference to the drawings.

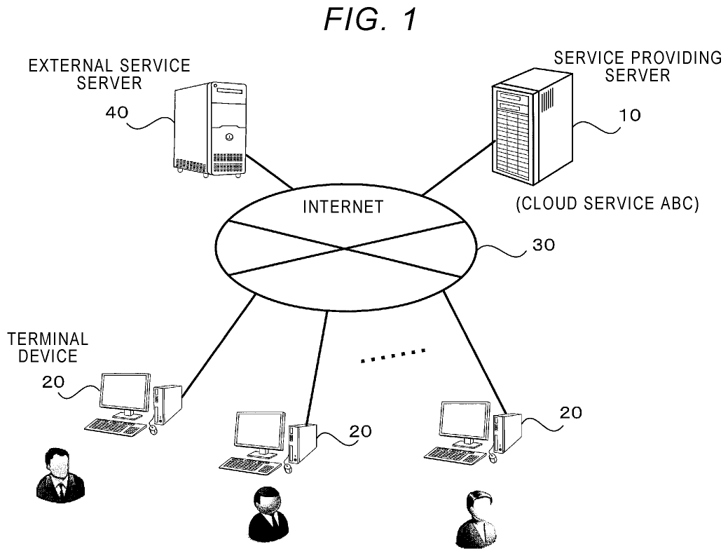

FIG. 1 is a diagram showing a system configuration of an information processing system according to one exemplary embodiment of the present disclosure.

As shown in FIG. 1, the information processing system according to the exemplary embodiment of the present disclosure has a configuration in which a service providing server 10, plural terminal devices 20, and an external service server 40 are connected to one another via the Internet 30.

The service providing server 10 is an information processing apparatus that provides a cloud service ABC to a user via the Internet 30. The external service server 40 provides, to the user, an external service different from the service provided by the service providing server 10.

Here, in a cloud service in recent years, a service providing method referred to as a multi-tenant that provides a service to plural user groups by using one system is used. The service providing server 10 provides the service to each user by using such a multi-tenant configuration.

When a service provided by a certain system is available to a tenant which is a user group including plural users, a specific user is selected from the tenant as a system administrator, and authority such as addition or deletion of a user (hereinafter, referred to as a general user) other than the system administrator who belongs to the tenant is entrusted to the system administrator.

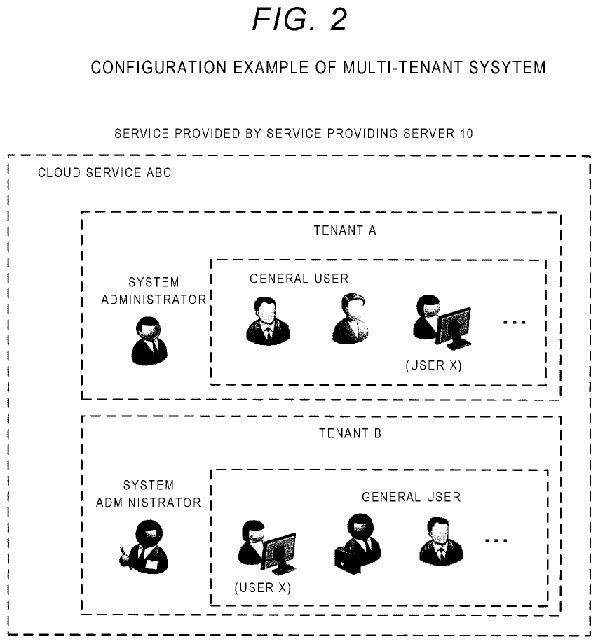

Such a multi-tenant configuration will be described with reference to FIG. 2. FIG. 2 shows a state in which users who use the service provided by the service providing server 10 include the users of plural tenants such as a tenant A, a tenant B, and the like. Here, a certain company may use the plural tenants. In such a case, the same user may be registered in different tenants. For example, in the example shown in FIG. 2, it can be seen that a user X is registered in both the tenant A and the tenant B.

In the cloud service ABC, services other than the tenant service are also provided, and even a user who is not registered in any tenant can use a part of the services of the cloud service ABC.

When plural services are provided via the Internet 30 as described above, it is troublesome for a user to perform login by inputting an account for each service, so that a function referred to as ID linking, which is mutual login of accounts capable of receiving provision of another service by using an account of a certain service, is provided. By using the ID linking, the user can use single-sign on (SSO) that can use plural cloud services only by inputting one piece of account information without managing many IDs and passwords.

However, when each service adopts a multi-tenant system, the number of tenants on which the ID linking with a tenant can be performed is often limited to one.

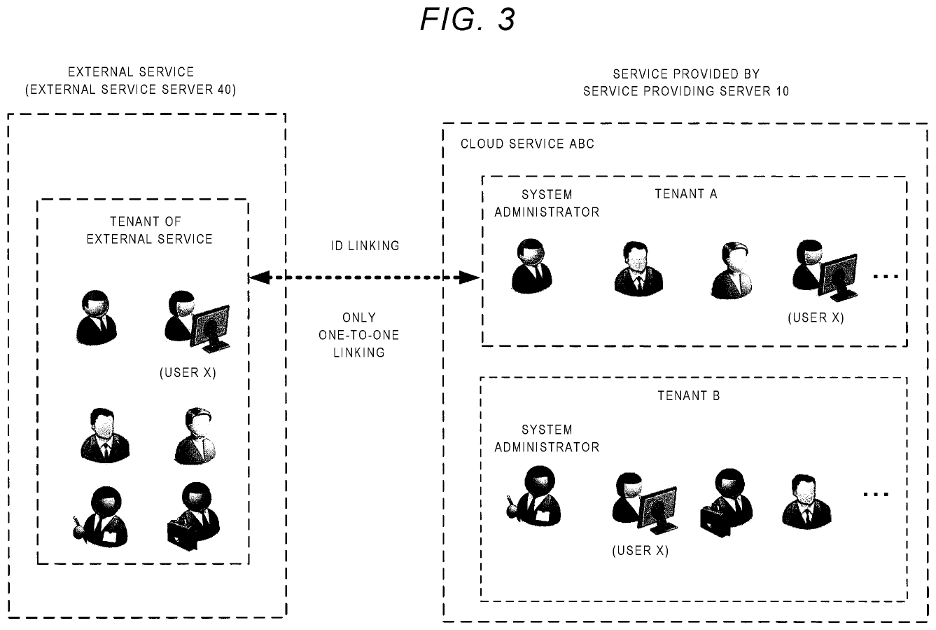

For example, as shown in FIG. 3, a case will be described in which tenants capable of performing the ID linking between the external service provided by the external service server 40 and the ABC service provided by the service providing server 10 are limited to one-to-one.

In such a case, it is assumed that a certain company creates a tenant in the external service and uses the service, and the company creates two tenants such as the tenant A and the tenant B, and uses the service in the cloud service ABC. Then, when performing ID linking between the external service and the cloud service ABC, the number of tenants in the cloud service ABC on which the ID linking with a tenant in the external service can be performed is limited to one. Therefore, the ID linking with only, for example, the tenant A can be performed.

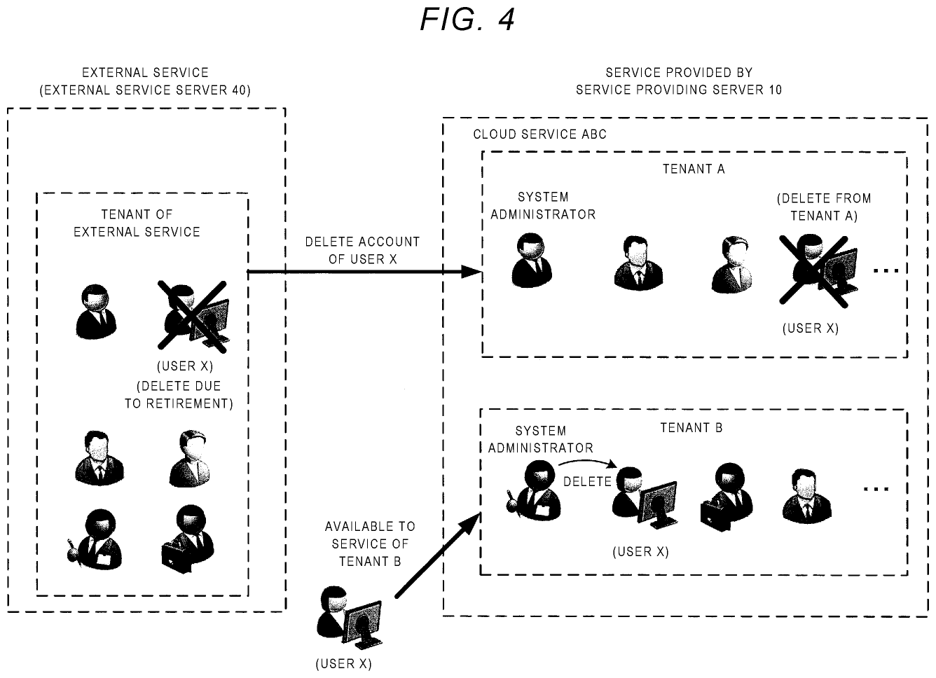

In such a case, for example, as shown in FIG. 4, when an account of the user X registered in the tenant in the external service is deleted due to retirement or the like, as long as deleting the account of the user X is notified from the tenant in the external service to the tenant A on which the ID linking is performed in the cloud service ABC, the account of the user X can be deleted in the tenant A.

In such a case, the account of the user X is still not deleted from the tenant B on which the ID linking with the tenant of the external service is not performed. Therefore, the user X can log in to the tenant B and use the service of the tenant B even though the user X has retired.

In this case, in order to delete the account of the user X from the tenant B, it is necessary for a system administrator of the tenant B to individually delete the user X.

In a case where a certain user uses a service that does not use the tenant in the cloud service ABC, that is, a service in which the system administrator does not exist, even when an account of the user is deleted from the certain tenant, the service that does not use the tenant in the cloud service ABC can be used.

Therefore, in the service providing server 10 of the present exemplary embodiment, by implementing the following processing, in a situation in which the multi-tenant system is adopted and only a certain tenant performs the ID linking with the external service, when an account of a certain user in the external service is invalidated, not only the account of the user in the tenant linked with the external service can be invalidated but also the account of the user in a tenant not linked with the external service can be invalidated.

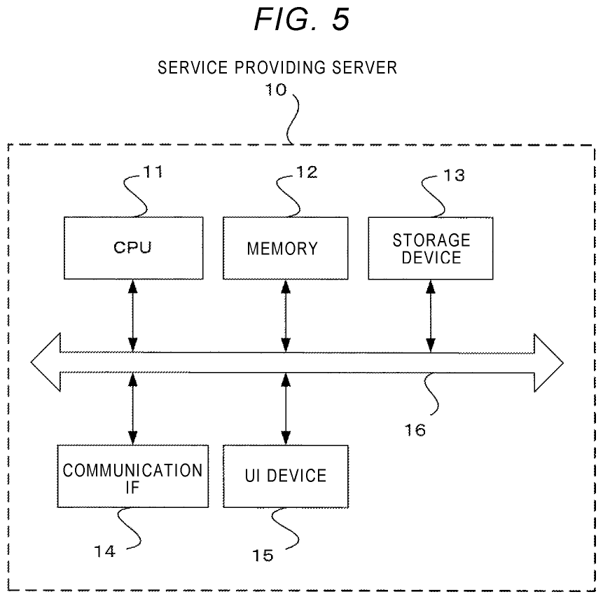

FIG. 5 shows a hardware configuration of the service providing server 10 in the information processing system according to the present exemplary embodiment.

As shown in FIG. 5, the service providing server 10 includes a CPU 11, a memory 12, a storage device 13 such as a hard disk drive, a communication interface (abbreviated as IF) 14 that transmits and receives data to and from an external device or the like via the Internet 30, and a user interface (abbreviated as UI) device 15 including a touch panel or a liquid crystal display, and a keyboard. These elements are connected to one another via a control bus 16.

The CPU 11 is a processor that executes predetermined processes based on a control program stored in the memory 12 or the storage device 13 to control an operation of the service providing server 10. In the present exemplary embodiment, the CPU 11 reads and executes the control program stored in the memory 12 or the storage device 13, but the program can also be stored in a storage medium such as a CD-ROM and provided to the CPU 11.

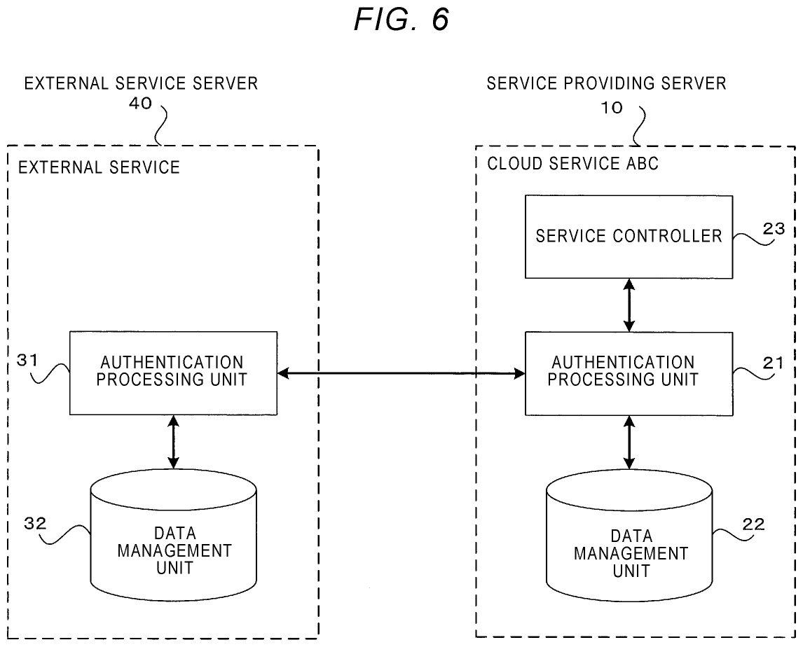

FIG. 6 is a block diagram showing a functional configuration of the service providing server 10 implemented by executing the control program.

As shown in FIG. 6, the service providing server 10 according to the present exemplary embodiment includes a service controller 23, an authentication processing unit 21, and a data management unit 22. The external service server 40 includes an authentication processing unit 31 and a data management unit 32.

The service controller 23 controls an overall operation of the service provided by the cloud service ABC.

The authentication processing unit 21 executes authentication processing in the cloud service ABC. When the ID linking is performed with the external service, the authentication processing unit 21 also executes the authentication processing on an account of the external service. Then, the authentication processing unit 21 executes the authentication processing based on authentication information managed by the data management unit 22.

The data management unit 22 manages account information such as a user ID and a password of each user. When the ID linking is performed with the external service, the data management unit 22 manages association information between the account of the external service and the account of the cloud service ABC.

The data management unit 32 in the external service server 40 manages account information such as a user ID and a password of each user in the external service. Then, the authentication processing unit 31 in the external service server 40 executes the authentication processing in the external service based on authentication information managed in the data management unit 32.

The authentication processing unit 31 in the external service and the authentication processing unit 21 in the cloud service ABC are linked with each other, and thus the ID linking between the tenant in the external service and the tenant in the cloud service ABC can be implemented.

When an account of a certain user in the external service is invalidated due to retirement or the like, by using the following method, the user can be prevented from using not only the tenant of the cloud service ABC that is linked with the external service but also the tenant that is not linked with the external service.

The method is a method in which, when the tenant in the cloud service ABC performs the ID linking with the tenant in the external service, login to the cloud service ABC is permitted only by the account information in the external service, and login to the cloud service ABC cannot be performed by the account information such as a user ID and a password of the cloud service ABC.

By using such a method, when the account information of the user on which the ID linking is performed between the external service and the cloud service ABC is deleted from the external service, the ID linking between the external service and the cloud service ABC is canceled, the account information of the external service cannot be used to log in to the cloud service ABC. Since the user cannot log in to the cloud service ABC by using the account information of the cloud service ABC, even when the user is registered in the plural tenants in the cloud service ABC, the user cannot use the services of all the tenants.

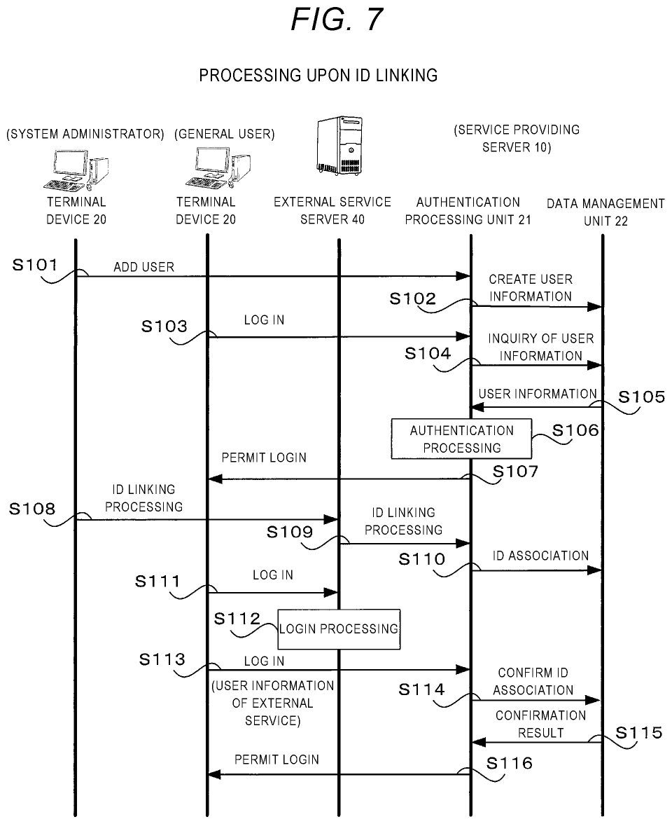

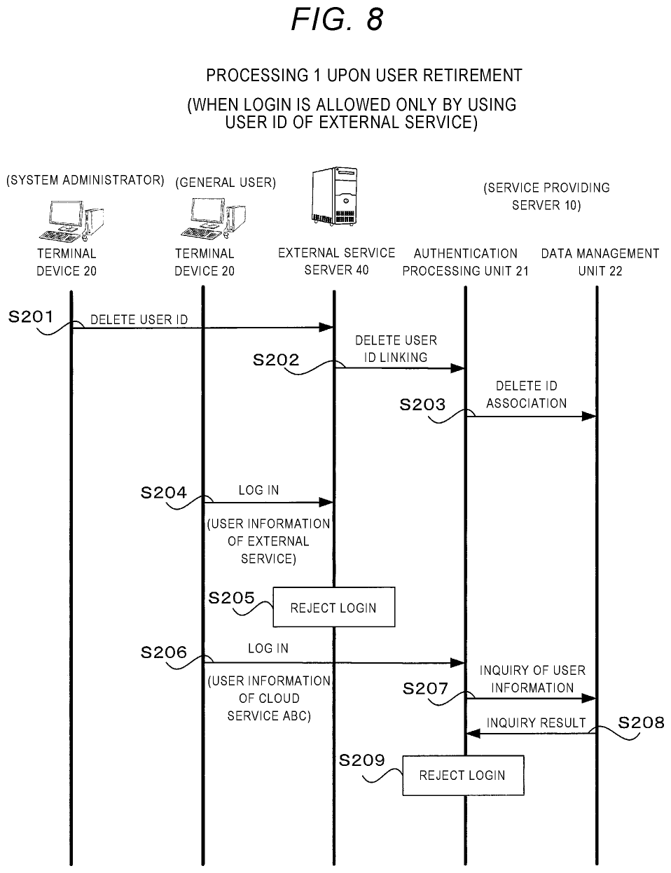

Operations when such a method is used will be described with reference to sequence charts of FIGS. 7 and 8.

FIG. 7 is a sequence chart for illustrating operations when the ID linking is performed between the external service and the cloud service ABC.

First, in step S101, the system administrator who operates the terminal device 20 adds a general user to the authentication processing unit 21 of the service providing server 10. Then, in step S102, the authentication processing unit 21 creates user information of the new general user for the data management unit 22.

Thereafter, when the added general user logs in to the service providing server 10 by operating the terminal device 20 in step S103, the authentication processing unit 21 makes an inquiry to the data management unit 22 for the user information of the user in step S104. When the authentication processing unit 21 obtains the user information from the data management unit 22 in step S105, the authentication processing unit 21 executes the authentication processing based on the obtained user information in step S106. Here, the description will be made on the assumption that the authentication processing is succeeded.

Based on a result of the authentication processing, in step S107, the authentication processing unit 21 permits the login of the general user who has performed the login.

Then, in the case where the ID linking is performed between the external service and the cloud service ABC, when the system administrator operates the terminal device 20 to execute the ID linking processing on the external service server 40 in step S108, the ID linking processing is executed between the authentication processing unit 31 in the external service server 40 and the authentication processing unit 21 in the service providing server 10 in step S109. Then, in step S110, the authentication processing unit 21 executes ID association for associating the account of the external service with the account of the cloud service ABC for the data management unit 22.

Thereafter, when the general user operates the terminal device 20 to present user information which is the account information such as a user ID and a password of the external service and to perform the login in step S111, the external service server 40 executes login processing in step S112.

When the general user operates the terminal device 20 to present user information, which is the account information such as the user ID and the password of the external service, and to perform the login in step S113, the authentication processing unit 21 confirms ID association information in the data management unit 22 in step S114. When the authentication processing unit 21 confirms that the account information of the user in the external service and the account information of the cloud service ABC are associated with each other based on a confirmation result obtained in step S115, the authentication processing unit 21 permits the login of the user in step S116.

Here, in the method described above, it is not permitted to log in by the account information of the user in the cloud service ABC. Therefore, when the user who has the ID linking with the external service logs in by presenting the account information of the cloud service ABC, the login of the user is rejected.

In such a state, a case where a user who has the ID linking with the external service loses a right of using both the external service and the cloud service ABC due to retirement or the like will be described with reference to the sequence chart of FIG. 8.

When a certain user loses the right of using the services due to retirement or the like, in step S201, the system administrator operates the terminal device 20 to execute processing of deleting the account information such as a user ID of the user from the external service server 40. Then, in step S202, the external service server 40 executes processing of deleting the ID linking of the user from the authentication processing unit 21 of the service providing server 10.

Then, in step S203, the authentication processing unit 21 executes processing of deleting the ID association of the user from the data management unit 22. By executing such processing, the ID linking of the retired user is canceled.

Then, in the external service server 40, since the user ID of the user is deleted, even when the user requests to log in to the external service server 40 by presenting the user information of the external service in step S204, the external service server 40 rejects the login request in step S205.

When the user requests the authentication processing unit 21 of the service providing server 10 for login by presenting the user information, which is the account information in the cloud service ABC, in step S206, the authentication processing unit 21 makes an inquiry to the data management unit 22 about the user information of the user in step S207.

Then, in step S208, the authentication processing unit 21 obtains the user information of the user, and grasps, based on the obtained user information, that the user cannot log in by using the account information of the user due to the ID linking with the external service. As a result, in step S209, the authentication processing unit 21 rejects the login request from the user. That is, the user whose account information in the external service is deleted due to retirement or the like cannot log in to the cloud service ABC, and cannot use all of the services in the cloud service ABC.

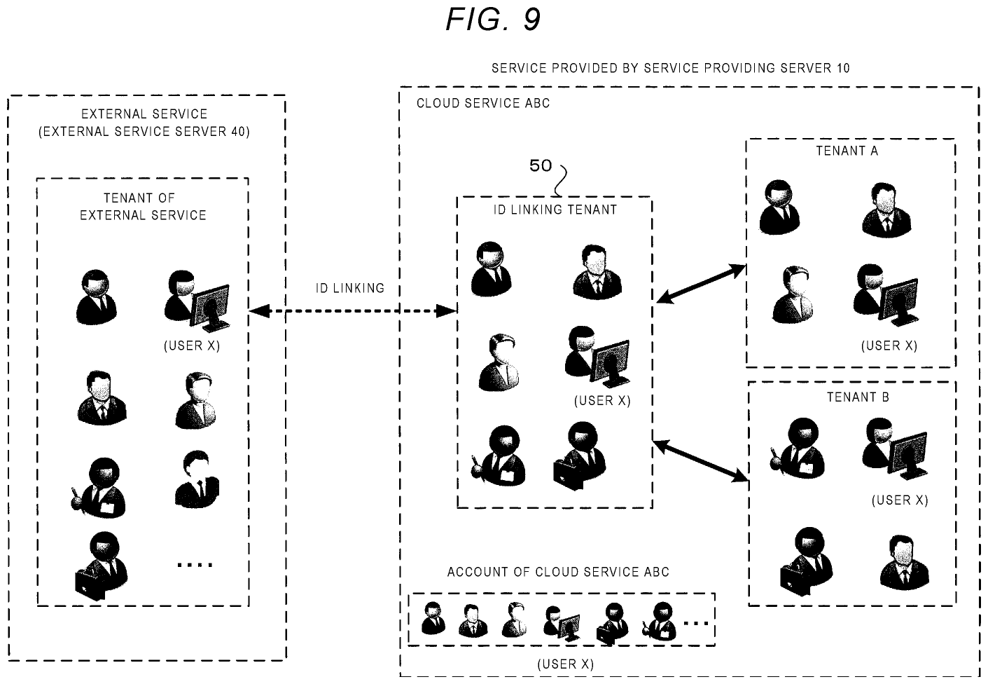

In the cloud service ABC according to the present exemplary embodiment, as shown in FIG. 9, an ID linking tenant 50, which is an account linking service for performing account linking with the external service, is provided in the own system. With such a configuration, in the cloud service ABC, the ID linking with the tenant of the external service is not directly performed by the tenants A, B, but performed via the ID linking tenant 50.

When performing the account linking with the external service, the ID linking tenant 50 performs the ID linking in which the use of the service in the own system is permitted depending on the account for which the authentication processing is executed in the external service.

Then, the system administrators of the tenants A, B register a user selected from users registered in the ID linking tenant 50 into the tenant.

When the ID linking tenant 50 receives a notification indicating that an account of a certain user is invalidated from the external service with which the account linking is performed, the authentication processing unit 21 deletes the account of the user in an own service, and invalidates or forcibly deletes the account of the own system linked with the invalidated account.

In the ID linking tenant 50, whether to invalidate or forcibly delete the account of the own system linked with the account invalidated in the external service may be set in advance.

When the account of the own system linked with the account invalidated in the external service is invalidated, the ID linking tenant 50 may notify other tenant services in the own system of information on the invalidated account.

When the account of the own system linked with the account invalidated in the external service is forcibly deleted, the ID linking tenant 50 may notify other services in the own system to delete information on the forcibly deleted account.

Next, operations of the cloud service ABC provided by the service providing server 10 according to the present exemplary embodiment will be described in detail with reference to the drawings.

In the present exemplary embodiment, in the ID linking tenant 50, whether to invalidate or forcibly delete the account in the own system of the user whose account is invalidated in the external service can be set in advance as a tenant policy. Here, the invalidation of the account means that the account information such as the user ID/password remains as it is, but the login using the account information is not permitted. The forced deletion of the account means that the account information such as the user ID/password of the user is deleted and the login using the account information is not permitted. When the account of the cloud service ABC is simply forcibly deleted, user data and the like of the user in the tenants A, B remain as it is.

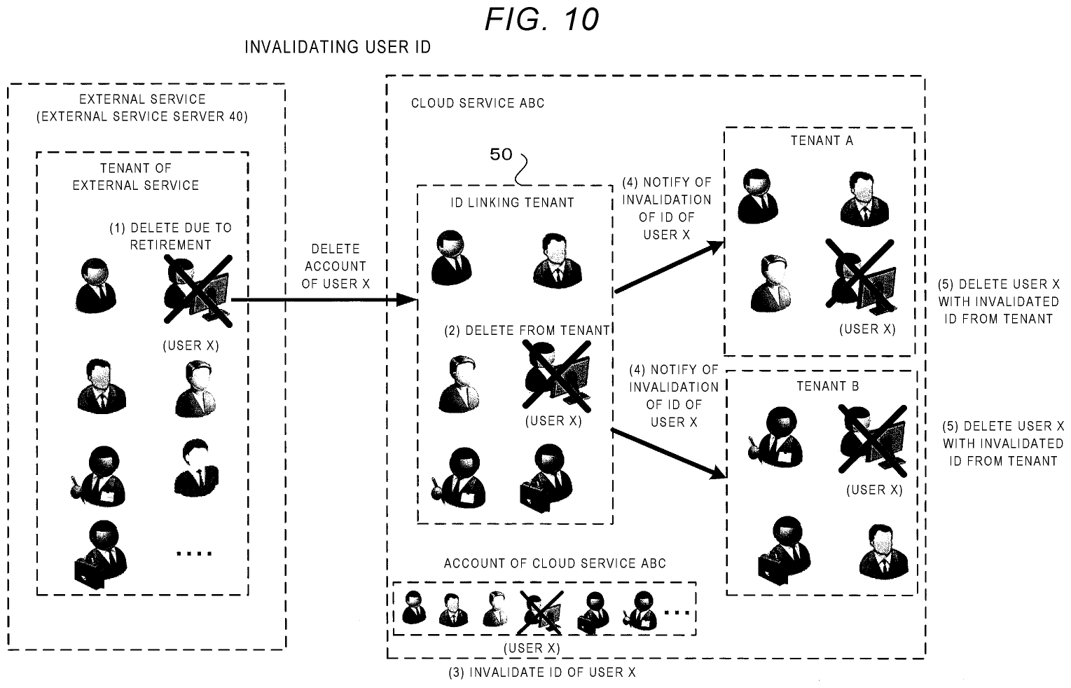

First, operations in a case where a user ID, which is account information in the own system of a user whose account is invalidated in the external service, is invalidated are shown in FIG. 10. In the following description, a case will be described in which the user X has retired from a company which creates a tenant in the external service or the cloud service ABC and uses the service.

Referring to FIG. 10, (1) first, in the tenant of the external service, the account of the user X is deleted due to retirement of the user X.

(2) Then, since the account of the user X is deleted, the ID linking tenant 50 deletes the account of the user X registered in the own tenant.

(3) Processing of invalidating a user ID of the user X in the cloud service ABC is executed.

(4) Then, the ID linking tenant 50 notifies the tenants A, B that the user ID of the user X is invalidated.

(5) Then, the system administrator in each of the tenants A, B, executes processing of deleting the account of the user X whose user ID is invalidated from the tenant, and deleting license information of the user from resource information.

By executing such processing, even when the user X tries to log in to the cloud service ABC, the login is rejected and the service of the cloud service ABC cannot be used.

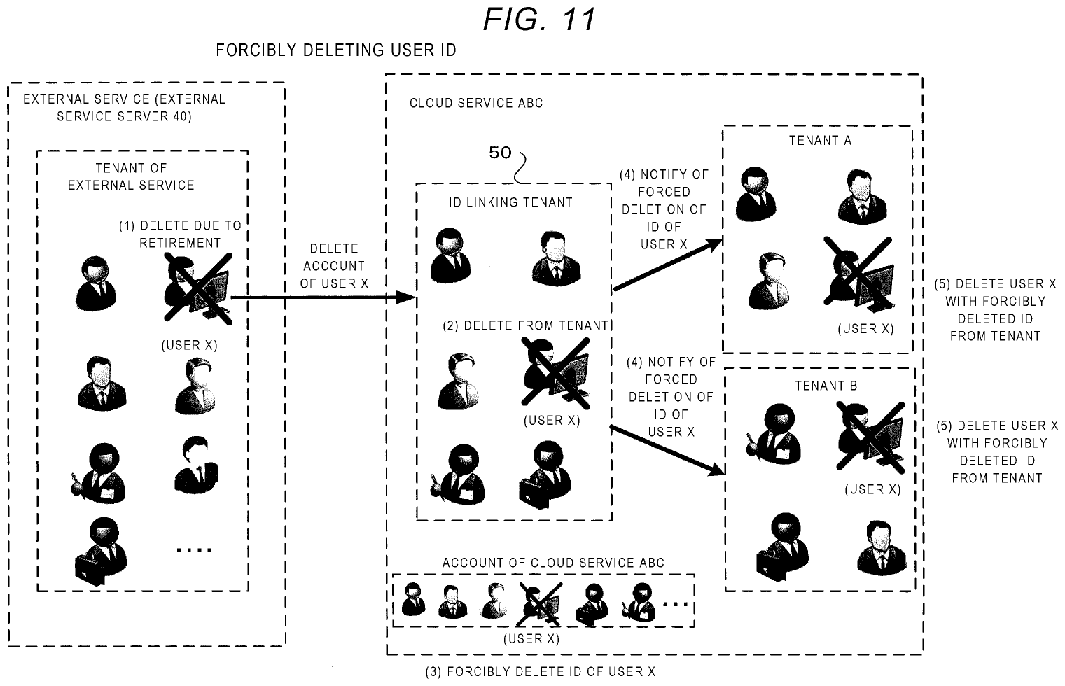

Next, operations in a case where a user ID, which is account information in the own system of a user whose account is invalidated in the external service, is forcibly deleted are shown in FIG. 11.

Referring to FIG. 11, (1) first, in the tenant of the external service, the account of the user X is deleted due to retirement of the user X.

(2) Then, since the account of the user X is deleted, the ID linking tenant 50 deletes the account of the user X registered in the own tenant.

(3) Processing of forcibly deleting the user ID of the user X in the cloud service ABC is executed.

(4) Then, the ID linking tenant 50 notifies the tenants A, B that the user ID of the user X is forcibly deleted.

(5) Then, the system administrator in each of the tenants A, B, executes processing of deleting the account of the user X whose user ID is forcibly deleted from the tenant, and deleting the license information of the user from the resource information.

By executing such processing, even when the user X tries to log in to the cloud service ABC, the login is rejected and the service of the cloud service ABC cannot be used.

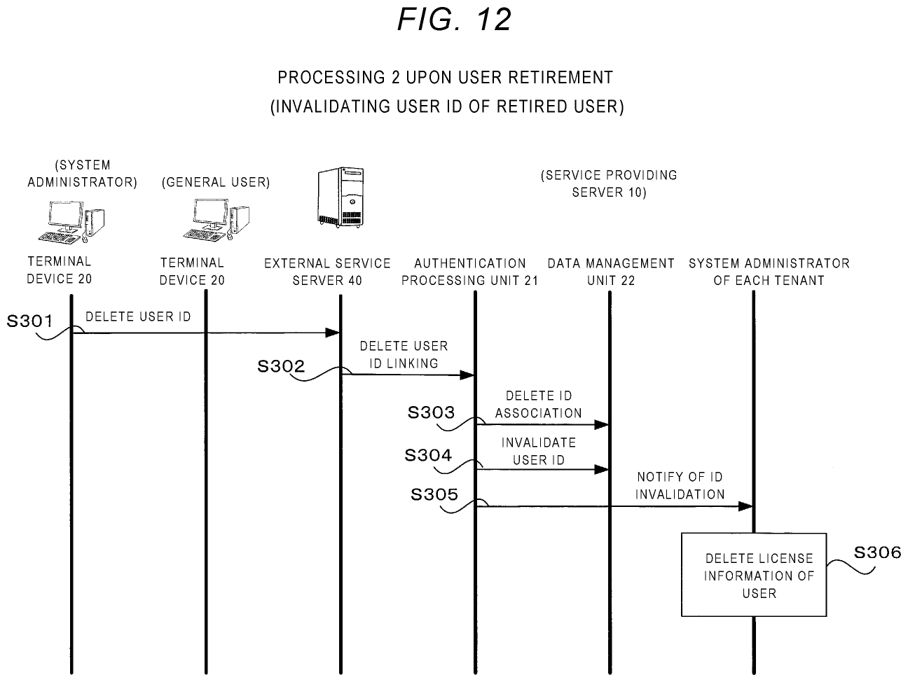

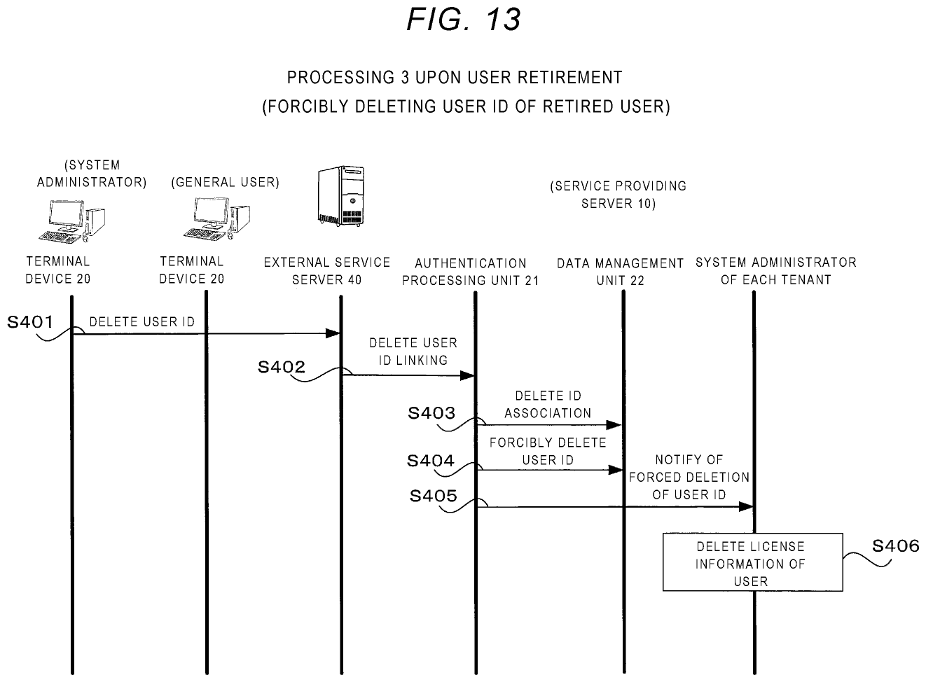

Next, operations when the account of the user X is invalidated in the external service as described above will be described with reference to sequence charts of FIGS. 12 and 13.

The operations in the case where the user ID, which is the account information in the own system of the user whose account is invalidated in the external service, is invalidated are shown in FIG. 12.

When a certain user loses the right of using the services due to retirement or the like, in step S301, the system administrator operates the terminal device 20 to execute the processing of deleting the account information such as the user ID of the user from the external service server 40. Then, in step S302, the external service server 40 executes processing of deleting the ID linking of the user from the authentication processing unit 21 of the service providing server 10.

Then, in step S303, the authentication processing unit 21 executes processing of deleting the ID association of the user from the data management unit 22. By executing such processing, the ID linking of the retired user is canceled.

In step S304, the authentication processing unit 21 invalidates the user ID of the user X managed by the data management unit 22. Finally, in step S305, the authentication processing unit 21 notifies the system administrator of each tenant that the user ID of the user X is invalidated.

Then, in step S306, the system administrator in each tenant executes processing of deleting the license information and the resource information of the user X.

Next, the operations in the case where the user ID, which is the account information in the own system of the user whose account is invalidated in the external service, is forcibly deleted are shown in FIG. 13.

When a certain user loses the right of using the services due to retirement or the like, in step S401, the system administrator operates the terminal device 20 to execute the processing of deleting the account information such as the user ID of the user from the external service server 40. Then, in step S402, the external service server 40 executes the processing of deleting the ID linking of the user from the authentication processing unit 21 of the service providing server 10.

Then, in step S403, the authentication processing unit 21 executes the processing of deleting the ID association of the user from the data management unit 22. By executing such processing, the ID linking of the retired user is canceled.

Then, in step S404, the authentication processing unit 21 forcibly deletes the user ID of the user X managed by the data management unit 22 to forcibly remove the user X. Finally, in step S405, the authentication processing unit 21 notifies the system administrator of each tenant that the user ID of the user X is forcibly deleted. The authentication processing unit 21 notifies a service side of a deletion event indicating that the user ID of the user X is forcibly deleted.

Then, in step S406, the system administrator in each tenant executes the processing of deleting the license information and the resource information of the user X.

In the exemplary embodiments above, the term “processor” refers to hardware in a broad sense. Examples of the processor include general processors (e.g., CPU: Central Processing Unit) and dedicated processors (e.g., GPU: Graphics Processing Unit, ASIC: Application Specific Integrated Circuit, FPGA: Field Programmable Gate Array, and programmable logic device).

In the exemplary embodiments above, the term “processor” is broad enough to encompass one processor or plural processors in collaboration which are located physically apart from each other but may work cooperatively. The order of operations of the processor is not limited to one described in the exemplary embodiments above, and may be changed.

### MODIFICATION

In the above exemplary embodiment, the case where the ID linking is performed between the service provided by the service providing server 10 and the service provided by the external service server 40 has been described, but the present disclosure is not limited thereto, and the present disclosure can also be similarly applied to a case where the ID linking as described above is performed between various information processing apparatuses.

The foregoing description of the exemplary embodiments of the present disclosure has been provided for the purposes of illustration and description. It is not intended to be exhaustive or to limit the disclosure to the precise forms disclosed. Obviously, many modifications and variations will be apparent to practitioners skilled in the art. The exemplary embodiments were chosen and described in order to best explain the principles of the disclosure and its practical applications, thereby enabling others skilled in the art to understand the disclosure for various exemplary embodiments and with the various modifications as are suited to the particular use contemplated. It is intended that the scope of the disclosure be defined by the following claims and their equivalents.

What is claimed is:

1. An information processing apparatus comprising:
a processor configured to:
provide, in an own system, an account linking service for performing account linking with an external service; and
when the account linking service receives a notification indicating that an account of a user is invalidated from the external service with which the account linking is performed, delete an account of the user in an own service, and invalidate or forcibly delete an account of the own system linked with the invalidated account.

2. The information processing apparatus according to claim 1, wherein in the account linking service, whether to invalidate or forcibly delete the account of the own system linked with the account invalidated in the external service can be set in advance.

3. The information processing apparatus according to claim 1, wherein when the account of the own system linked with the account invalidated in the external service is invalidated, the account linking service notifies another service in the own system of information on the invalidated account.

4. The information processing apparatus according to claim 2, wherein when the account of the own system linked with the account invalidated in the external service is invalidated, the account linking service notifies another service in the own system of information on the invalidated account.

5. The information processing apparatus according to claim 1, wherein when the account of the own system linked with the account invalidated in the external service is forcibly deleted, the account linking service notifies another service in the own system to delete information on the forcibly deleted account.

6. The information processing apparatus according to claim 2, wherein when the account of the own system linked with the account invalidated in the external service is forcibly deleted, the account linking service notifies another service in the own system to delete information on the forcibly deleted account.

7. The information processing apparatus according to claim 1, wherein when the account linking with the external service is performed, the account linking service permits use of a service in the own system depending on an account for which authentication processing is executed in the external service.

8. The information processing apparatus according to claim 2, wherein when the account linking with the external service is performed, the account linking service permits use of a service in the own system depending on an account for which authentication processing is executed in the external service.

9. The information processing apparatus according to claim 3, wherein when the account linking with the external service is performed, the account linking service permits use of a service in the own system depending on an account for which authentication processing is executed in the external service.

10. The information processing apparatus according to claim 4, wherein when the account linking with the external service is performed, the account linking service permits use of a service in the own system depending on an account for which authentication processing is executed in the external service.

11. The information processing apparatus according to claim 5, wherein when the account linking with the external service is performed, the account linking service permits use of a service in the own system depending on an account for which authentication processing is executed in the external service.

12. The information processing apparatus according to claim 6, wherein when the account linking with the external service is performed, the account linking service permits use of a service in the own system depending on an account for which authentication processing is executed in the external service.

13. A non-transitory computer readable medium storing a program causing a computer to execute information processing, the information processing comprising:
providing, in an own system, an account linking service for performing account linking with an external service; and
when the account linking service receives a notification indicating that an account of a user is invalidated from the external service with which the account linking is performed, deleting an account of the user in an own service, and invalidating or forcibly deleting an account of the own system linked with the invalidated account.

14. An information processing method comprising:
providing, in an own system, an account linking service for performing account linking with an external service; and
when the account linking service receives a notification indicating that an account of a user is invalidated from the external service with which the account linking is performed, deleting an account of the user in an own service, and invalidating or forcibly deleting an account of the own system linked with the invalidated account.
